(19) United States
(12) Patent Application Publication
(10) Pub. No.: US 2009/0194630 A1
(43) Pub. Date: Aug. 6, 2009

(54) STORAGE UNIT FOR STEREO HEADSET

(76) Inventor: Senthil Thiyagarajan, Fremont, CA (US)

Correspondence Address: The VON HELLENS LAW FIRM, LTD., 7330 N 16TH STREET, SUITE C 201, PHOENIX, AZ, 85020, US

(21) Appl. No.: 12/118,561

(22) Filed: May 9, 2008

Related U.S. Application Data
(60) Provisional application No. 60/945,047, filed on Jun. 19, 2007.

(51) Int. Cl. H02G 11/02; B65H 75/38; B65H 75/44; B65H 75/40

(52) U.S. Cl. 242/405.1; 191/12.4

(57) ABSTRACT

A winding case of a storage unit includes a spool-like element for winding thereabout a cable interconnecting an audio jack and a pair of ear buds. A housing extending from the winding case retains the junction between the cable and the pair of conductors connected to the pair of ear buds. A lid hingedly attached to the housing permits insertion and removal of the junction. A further lid hingedly attached to the winding case permits insertion of the cable, winding of the cable about the spool-like element to reduce the operable length of cable and removal of the cable.

### CROSS REFERENCE TO RELATED APPLICATIONS

The present application includes subject matter disclosed in and claims priority to a provisional application entitled “WINDING CASE USED FOR EAR PHONES” filed Jun. 19, 2007 and assigned Ser. No. 60/945,047 describing an invention made by the present inventor.

### BACKGROUND OF THE INVENTION

1. Field of the Invention

The present invention relates to storage units and, more particularly, to a winding case for storing the cable interconnecting a pair of ear buds and an audio plug of a stereo headset.

2. Description of Related Prior Art

Portable audio devices, such as AM/FM radios, recorders and, various types of audio players and laptop computers include a receptacle for receiving an audio jack attached to ear phones or ear buds. Generally, the cable interconnecting the ear buds and the audio jack of a stereo headset is somewhat lengthy and tends to become caught on clothing and other obstacles when in use. This dangling cable is particularly troublesome when a listener is moving.

Another problem relates to storage of the stereo headset when not in use. Often, storage is either in a loose configuration or within a protective container. In the former event, the ear buds, audio jack and cable are susceptible to damage. In the latter case, the size of the container that may be available is cumbersome or otherwise awkward to carry on one's person.

### SUMMARY OF THE INVENTION

A conventional stereo headset includes a pair of ear buds connectable through an audio jack to an audio source. A junction interconnects the conductor to each ear bud with the cable attached to the audio jack. The winding case of a storage unit includes a bifurcated spool-like element about which a length of the cable may be wound during use and a lid encloses the spool-like element and the cable wound thereabout. An outlet at one end of the case accommodates passage of the cable and attached audio jack. An outlet at the diametrically opposed end of the case is interconnected with a housing for enclosing the junction between the cable and the conductors leading to each ear bud. A lid closes the housing to secure the junction therein and positionally mount the storage unit on the stereo headset. In use, the cable is unwound from about the spool-like element to the extent necessary with the cable extending within the bifurcation of the spool-like element whether all or some of the cable is wound about the spool-like element. For storage purposes, the cable is wound completely or nearly completely about the spool-like element and the audio jack may be located externally or in the bifurcation of the spool-like element to protect it upon closure of the lid for the case.

It is therefore a primary object of the present invention to provide a storage unit for the cable interconnecting a pair of ear buds with an audio jack of a stereo headset.

Another object of the present invention is to provide a winding case for accommodating a selectable length of cable extending from a pair of ear buds to an audio jack.

Yet another object of the present invention is to provide a winding case positionally fixed with respect to a cable extending from an audio jack to a pair of ear buds.

Still another object of the present invention is to provide a storage unit usable with commercially available stereo headsets having ear buds connected to an audio jack with a cable.

A further object of the present invention is to provide a compact winding case for storing the cable of a stereo headset.

A yet further object of the present invention is to provide a method for storing and selectively extending the cable supporting an audio jack and interconnected with a pair of ear buds.

These and other objects of the present invention will become apparent to those skilled in the art as the description thereof proceeds.

### BRIEF DESCRIPTION OF THE DRAWINGS

The present invention will be described with greater specificity and clarity with reference to the following drawings, in which:

FIG. 1 illustrates a storage unit with a pair of lids thereof being open;

FIG. 2 illustrates a conventional stereo headset having a pair of ear buds connected through a cable to an audio jack;

FIG. 3 illustrates the storage unit with the lids closed;

FIG. 4 is a cross sectional view taken along lines 4-4, as shown in FIG. 3;

FIG. 5 is a partial cross sectional view of a winding case and illustrating a bifurcated spool and a lid in the open position; and

FIG. 6 illustrates the cable of a stereo headset stored within or the storage unit with the ear buds and audio jack extending therefrom.

### DESCRIPTION OF THE PREFERRED EMBODIMENT

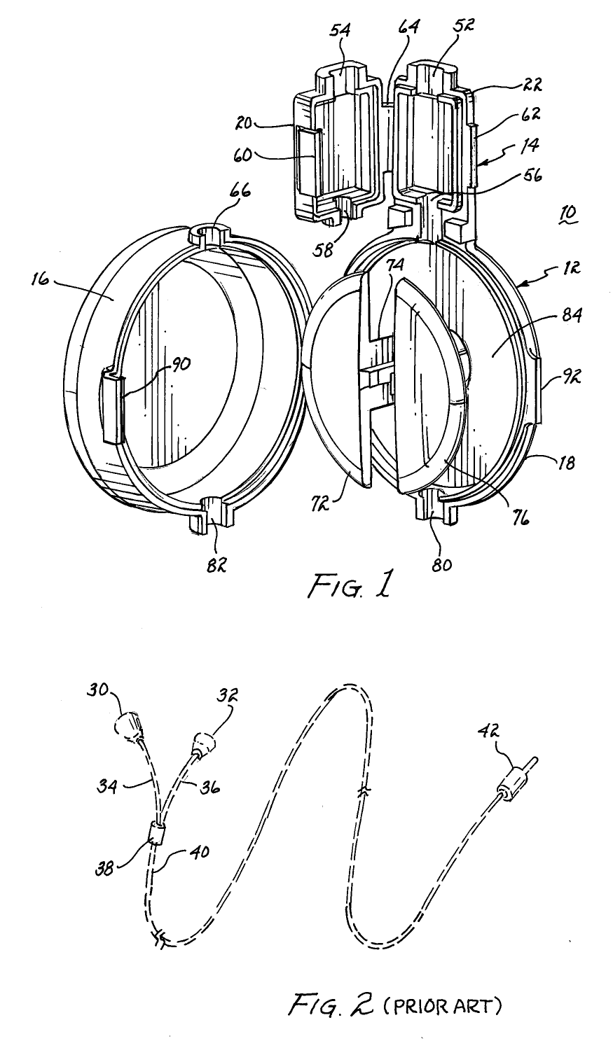

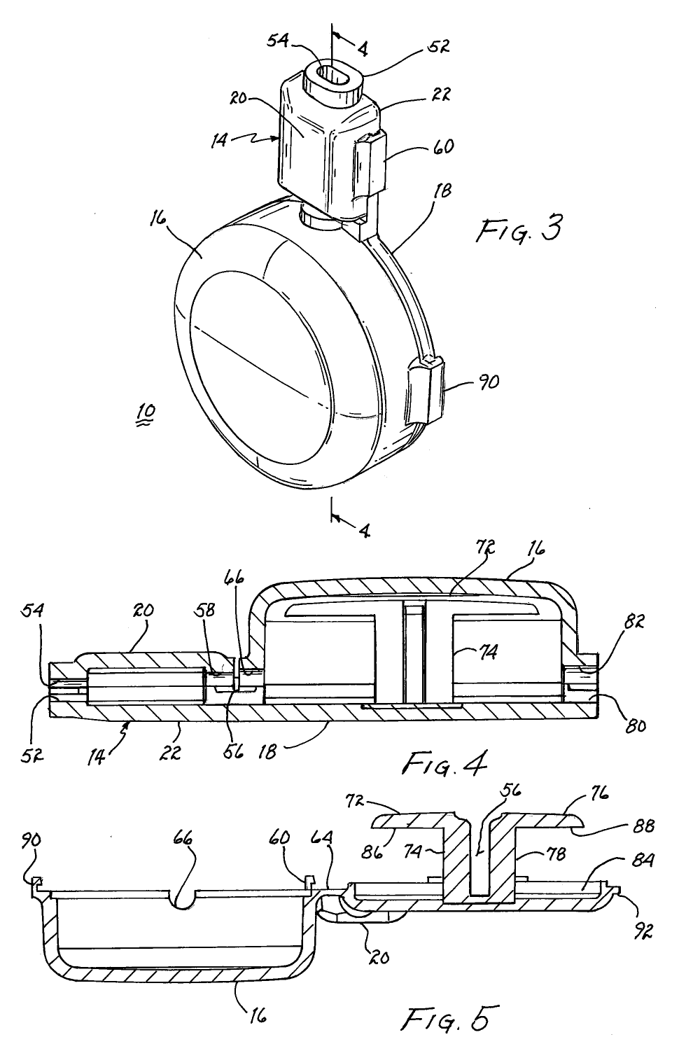

Referring to FIG. 1, there is illustrated a storage unit 10 formed by a winding case 12 and a housing 14. The winding case includes a lid 16 hingedly attached to a base 18. Housing 14 includes a lid 20 attached to a base 22. Base 18 of the winding case is structurally attached to base 22 of housing 14 by an interconnecting bridge 24. Thereby, the winding case and the housing are essentially a unitary structure.

A conventional stereo headset is shown in FIG. 2. A pair of ear buds 30, 32 are connected by conductors 34, 36 respectively, to a junction 38. A cable 40 extends from junction 38 to an audio jack 42 for plug-in engagement with an audio source. In operation, audio signals are transmitted from audio jack 42 through cable 40 to junction 38. Within the junction, the stereophonic sound conveyed by cable 40 is split to a left and right audio signal. Each of the audio signals is transmitted through one of conductors 34, 36 to the respective ear bud. Thereby, a listener will hear a stereophonic sound. In the event the sound transmitted through cable 40 is monophonic, the same audio signals will appear in each of ear buds 30, 32.

Generally, the length of cable 40 is designed by the manufacturers to accommodate an expected maximum distance from the audio source providing the signals to audio jack 42 and the ears of a listener. Usually, the actual distance when such audio source is in use is significantly less and excess cable exists, which is a nuisance. Moreover, no storage compartments exist which are detachably attached to a cable that can accommodate a selectable length of cable and storage for the cable.

Referring to FIG. 1, housing 14 includes a compartment 50 formed in part by each of base 22 and lid 20. This compartment houses junction 38 (see FIG. 2) and detachably attaches storage unit 10 to the stereo headset. A channel 52 in base 22 and a mating channel 54 in lid 20 accommodate passage therethrough of conductors 34, 36. A further channel 56 in base 22 in combination with channel 58 in lid 20 accommodate passage therethrough of cable 40. A flexible hinge 64 interconnects base 22 with lid 20 to accommodate opening and closing of the lid while retaining the lid attached to the base. Upon closure of lid 20 with base 22, a snap lock 60 extending from lid 20 engages a ridge 62 in base 22 to retain the lid in the closed position and from a disc shaped unit. Thereby, conductors 34, 36 extend from housing 14 for use and cable 40 extends into winding case 12 for storage and selectable extension therefrom.

Lid 16 of winding case 12 includes a channel 66 in operative relationship with channel 56 to accommodate passage of cable 40 therethrough. As shown in further detail in FIGS. 1, 4 and 5, a bifurcated pedestal formed by stanchions 74, 78 extends from base 18. A generally semicircular disc 72 is supported at the top of stanchion 74. A similar semicircular disc 76 is supported upon a stanchion 78. A channel 80 is disposed in the perimeter of base 18 in general diametric alignment with channel 56. A channel 82 is disposed in lid 16 in general diametric alignment with channel 66. Upon closure of lid 16 with base 18, channels 80 and 82 collectively define a passageway. As clearly illustrated in FIG. 5, the space between stanchions 74 and 78 is in general alignment with the axis of channels 56 and 80 in base 18. Semicircular discs 72 and 76 collectively and in combination with surface 84 of base 18 define a structure in the nature of a spool-like element.

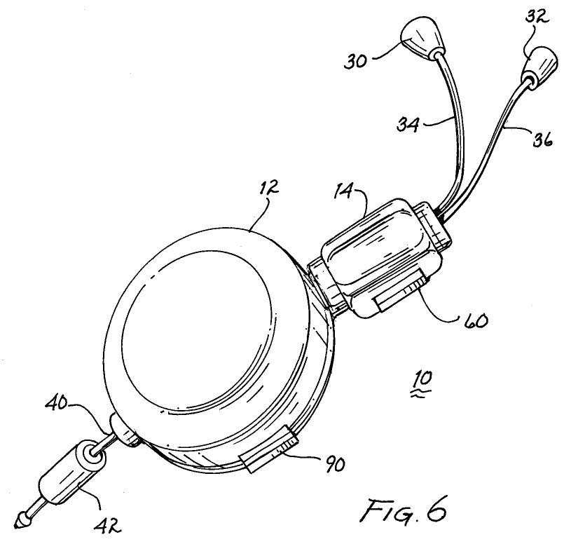

Cable 40, extending from junction 38 enclosed within housing 14, may extend through winding case 12 by being placed in channel 56 intermediate stanchions 74, 78 and channel 80 for a direct pass through. To shorten cable 40, the cable extending from the passageway defined by channels 56/58 is wrapped about stanchions 74, 78 within the space defined by surface 84 of base 18 and under sides 86, 88 of semicircular discs 72, 76, respectively. The end of cable 40 supporting audio jack 84 may extend from the winding case, as shown in FIG. 6. Audio jack 84 may be placed either intermediate stanchions 74, 78 or within the spool-like area adjacent surface 84 to fully contain cable 40 within winding case 12 if there is sufficient space. In the event the audio jack is to be connected with an audio source, a selected length of cable 40 is unwrapped from about stanchions 74, 78 and placed within channel 80. Thereafter, lid 16 is closed with base 18. To retain lid 16 closed with base 18, a snap lock 90 engaging a ridge 92 may be employed. The lid is retained with the base through a flexible hinge 94 (see FIG. 5). Thereby, none of the elements of cord storage unit 10 on the stereo headset can be lost or misplaced. It may be noted that by maintaining junction 38 within housing 14, storage unit 10 will always be attached to cable 40 and loss or misplacement is highly unlikely.

As shown in FIG. 6, winding case 12 may be disc shaped to accommodate the spool-like element formed therein. Furthermore, the disc shape minimizes its size and weight. Housing 14 may be in the form of a rectangular box to accommodate the junction therein and of minimal size to reduce its weight. It is to be understood that either or both the winding case and housing may be differently shaped.

I claim:

1. A storage unit for a stereo headset, which stereo headset includes a pair of ear buds, a cable extending from a junction of conductors connected to the ear buds and terminated by an audio jack, said storage unit comprising in combination:
a) a housing having a hingedly attached lid for receiving and capturing the junction;
b) passageways disposed in opposite sides of said housing for accommodating the conductors extending to the ear buds and the cable extending in an opposed direction from the conductors;
c) a winding case supporting said housing and a lid hingedly attached to said winding case for storing some or all of the cable within said winding case;
d) a first passageway disposed in said winding case for receiving the cable from said housing and a second passageway disposed in said winding case for accommodating passage of the cable terminated by the audio jack; and
e) each stanchion of a pair of stanchions supporting one semicircular disc of a pair of semicircular discs disposed intermediate said first and second passageways for accommodating winding of the cable about said pair of stanchions between said first and second passageways.

2. The storage unit as set forth in claim 1 including a channel disposed intermediate said pair of stanchions.

3. The storage unit as set forth in claim 1, wherein said winding case includes a base, said pair of semicircular discs in combination with said base forming a spool-like element.

4. A cable storage unit for a stereo headset, said storage unit comprising in combination:
a) a winding case having a base and a lid;
b) said base including a pair of stanchions extending from said base and defining a channel therebetween;
c) a pair of essentially semicircular discs, one semicircular disc of said pair of semicircular discs extending from each stanchion of said pair of stanchions to define in combination with said base a spool-like element for supporting a cable of the stereo headset;
d) a first passageway disposed in said winding case for accommodating egress of the cable;
e) a housing attached to said winding case for accommodating capture of a junction between the cable and a pair of conductors of the stereo headset, each of the conductors supporting an ear bud;
f) a second passageway extending between said winding case and said housing for accommodating passage of the cable from said housing into said winding case;
g) a third passageway in said housing for accommodating egress of the pair of conductors; and
h) said housing including a further lid for accommodating insertion and removal of the junction.

5. A storage unit as set forth in claim 4, wherein said lid is hingedly attached to said base.

6. A storage unit as set forth in claim 5, including a snap lock for securing said lid to said base.

7. A storage unit as set forth in claim 4, wherein said further lid is hingedly attached to said housing.

8. A storage unit as set forth in claim 7, including a snap lock for securing said further lid to said housing.

9. A storage unit as set forth in claim 7, wherein said lid is hingedly attached to said base.

10. A storage unit as set forth in claim 4, wherein said housing is formed as a part of said winding case.

11. A storage unit as set forth in claim 4, wherein said winding case is disc shaped.

12. A storage unit as set forth in claim 4, wherein said housing is rectangular.

13. A storage unit as set forth in claim 4, wherein said first passageway is formed by a channel in each of said base and said lid.

14. A storage unit as set forth in claim 4, wherein said second passageway is formed by a channel in each of said base, said lid, said housing and said further lid.

15. A storage unit as set forth in claim 4, wherein said third passageway is formed by a channel in each of said housing and said further lid.

16. A storage unit as set forth in claim 4, wherein said first passageway, said second passageway, said third passageway and said channel between said pair of stanchions are essentially in rectilinear alignment.

17. A method for storing a stereo headset, said method comprising the steps of:
a) securing within a housing the junction between an audio cable supporting an audio jack and a pair of conductors connected to respective ear buds;
b) winding the audio cable about a pair of stanchions disposed in a winding case;
c) locating the cable in a bridge interconnecting the housing and the winding case; and
d) extending the cable and attached audio jack through a passageway of the winding case.

18. The method as set forth in claim 17, including the step of opening a lid attached to the winding case and the step of winding a selected length of the cable about the stanchions.

19. The method as set forth in claim 17, including the step of placing a section of the cable in a channel intermediate the stanchions.

20. The method as set forth in claim 17, including the step of opening a lid attached to the housing and selectively joining and separating the junction and the housing.
